(19) United States
(12) Patent Application Publication
(10) Pub. No.: US 2025/0379469 A1
(43) Pub. Date: Dec. 11, 2025

(54) POWER MANAGEMENT APPARATUS, POWER MANAGEMENT METHOD, AND PROGRAM

(71) Applicant: KYOCERA CORPORATION, Kyoto (JP)

(72) Inventors: Kenta OKINO, Kyoto (JP); Kazutaka NAKAMURA, Kyoto (JP)

(21) Appl. No.: 18/878,648

(22) PCT Filed: Jun. 15, 2023
(86) PCT No.: PCT/JP2023/022274

§ 371 Date: Dec. 24, 2024

(30) Foreign Application Priority Data
Jun. 28, 2022 (JP) 2022-103922

(51) Int. Cl. H02J 13/00; G06Q 50/06

(52) U.S. Cl. CPC H02J 13/00022; G06Q 50/06; H02J 13/00002

(57) ABSTRACT

A power management apparatus includes: a manager configured to manage one or more facilities connected to a power system; a controller configured to perform specific control to control a distributed power supply installed at each of the one or more facilities; and a receiving unit configured to receive first rate-related information regarding a first electricity rate determined between an electricity market and an electricity retailer that sells power to each of the one or more facilities. The controller performs the specific control based on the first rate-related information.

### RELATED APPLICATIONS

The present application is a National Phase of International Application Number PCT/JP2023/022274 filed Jun. 15, 2023, which claims the benefit of priority from Japanese Patent Application No. 2022-103922, filed on Jun. 28, 2022.

### TECHNICAL FIELD

The present disclosure relates to a power management apparatus, a power management method, and a program.

### BACKGROUND OF INVENTION

In recent years, a technology in which a power storage apparatus is used as a distributed power supply in order to maintain a power supply-demand balance of a power system (for example, a virtual power plant (VPP)) is known (for example, Patent Documents 1 and 2).

Examples of an electricity retailer that sells electricity to facilities may include a local power provider or may include a new power provider other than the local power provider. Here, the new power provider is assumed to procure power from an electricity market (for example, a wholesale electricity market) and sell the power to the facilities.

In the VPP, a power management apparatus managed by a resource aggregator (RA) or the like is assumed to control distributed power supplies installed at one or more facilities (hereinafter referred to as a facility group). The RA is an entity differing from the electricity retailer.

For example, the power management apparatus is considered to control the distributed power supply installed at the facility such that a difference (imbalance) between a planned value for a forward power flow power (hereinafter, procured power) of the facility group and an actual value for procured power of the facility group is equal to or less than a predetermined difference.

The power management apparatus is considered to control the distributed power supply installed at the facility such that a difference (imbalance) between a planned value for reverse power flow power (hereinafter, generation power) of the facility group and an actual value for the generation power of the facility group is equal to or less than a predetermined difference.

### CITATION LIST

### Patent Literature

Patent Document 1: WO 2015/041010 pamphlet

Patent Document 2: WO 2016/084396 pamphlet

### SUMMARY

One aspect of the disclosure provides a power management apparatus including: a manager configured to manage one or more facilities connected to a power system; a controller configured to perform specific control to control a distributed power supply installed at each of the one or more facilities; and a receiving unit configured to receive first rate-related information regarding a first electricity rate determined between an electricity market and an electricity retailer that sells power to each of the one or more facilities, in which the controller performs the specific control based on the first rate-related information.

One aspect of the disclosure provides a power management method including: managing one or more facilities connected to a power system; performing specific control to control a distributed power supply installed at each of the one or more facilities; and receiving first rate-related information regarding a first electricity rate determined between an electricity market and an electricity retailer that sells power to each of the one or more facilities, in which the performing of the specific control includes performing the specific control based on the first rate-related information.

An aspect of the disclosure provides a program that causes a computer to perform: managing one or more facilities connected to a power system; performing specific control to control a distributed power supply installed at each of the one or more facilities; and receiving first rate-related information regarding a first electricity rate determined between an electricity market and an electricity retailer that sells power to each of the one or more facilities, in which the performing of the specific control includes performing the specific control based on the first rate-related information.

### BRIEF DESCRIPTION OF THE DRAWINGS

FIG. 1 is a diagram illustrating a power management system 1 according to an embodiment.

FIG. 2 is a diagram illustrating a facility 100 according to an embodiment.

FIG. 3 is a diagram illustrating a lower management server 200 according to an embodiment.

FIG. 4 is a diagram illustrating a higher management server 300 according to an embodiment.

FIG. 5 is a diagram for explaining an electricity rate and specific control according to an embodiment.

FIG. 6 is a diagram illustrating a power management method according to an embodiment.

FIG. 7 is a diagram illustrating a power management method according to an embodiment.

### DESCRIPTION OF EMBODIMENTS

Embodiments will be described below with reference to the accompanying drawings. In the following description of the drawings, the same or similar components will be denoted by the same or similar reference signs. However, the drawings are schematic.

### Embodiment

### Power Management System

A power management system according to an embodiment will be described below. The power management system may be simply referred to as a power system.

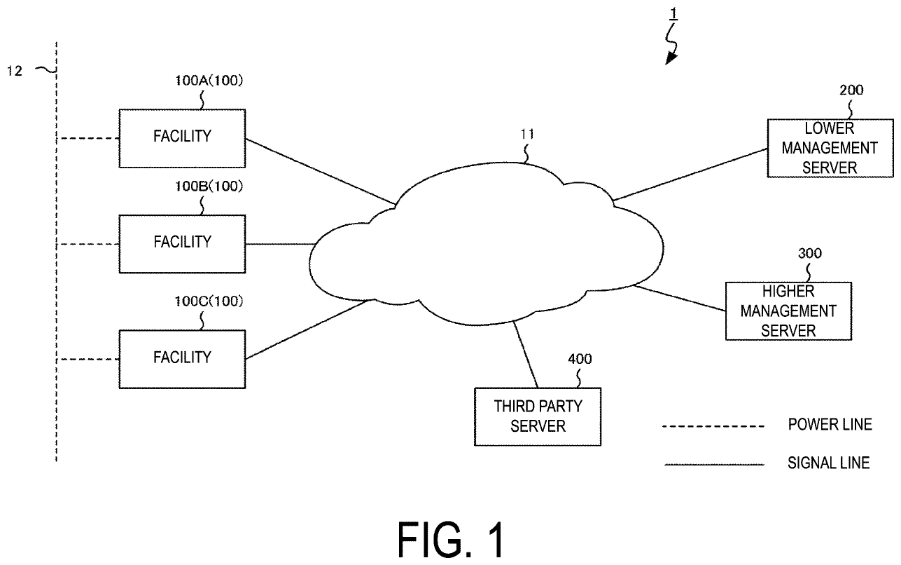

As illustrated in FIG. 1, a power management system 1 includes a facility 100. The power management system 1 includes a lower management server 200, a higher management server 300, and a third party server 400.

Here, the facility 100, the lower management server 200, the higher management server 300, and the third party server 400 are communicable with each other through a network 11. The network 11 may include the Internet, a dedicated line such as a virtual private network (VPN), or a mobile communication network.

The facility 100 is connected to a power system 12, and may be supplied with power from the power system 12 or may supply power to the power system 12. Power from the power system 12 to the facility 100 may be referred to as a forward power flow power. Power from the facility 100 to the power system 12 may be referred to as a reverse power flow power. FIG. 1 illustrates facilities 100A to 100C as examples of the facility 100.

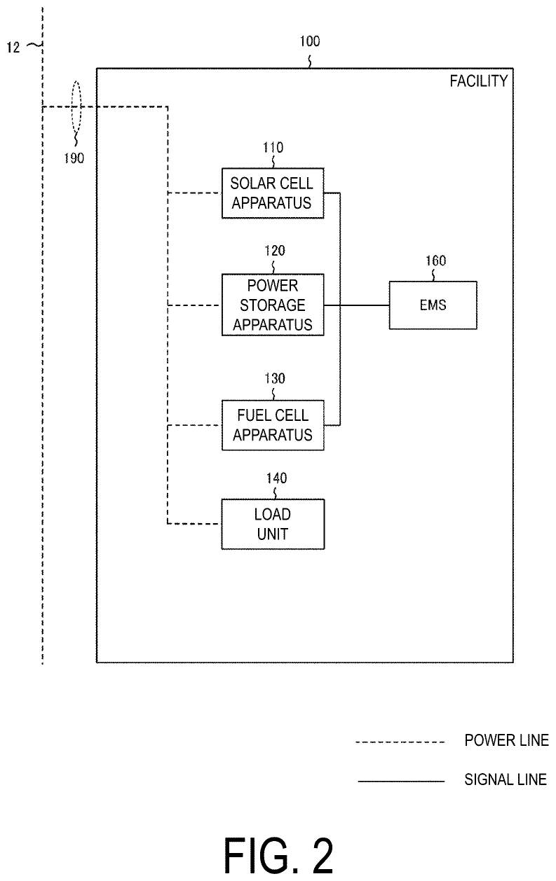

The facility 100 may be and is not particularly limited to a facility such as a residence, a shop, or an office. The facility 100 may be a residential complex including two or more residences. The facility 100 may be a complex facility including at least two facilities of residences, shops, and offices. The details of the facility 100 will be described below (see FIG. 2).

The lower management server 200 is managed by an operator that manages power related to the power system 12. The operator may be a resource aggregator (RA).

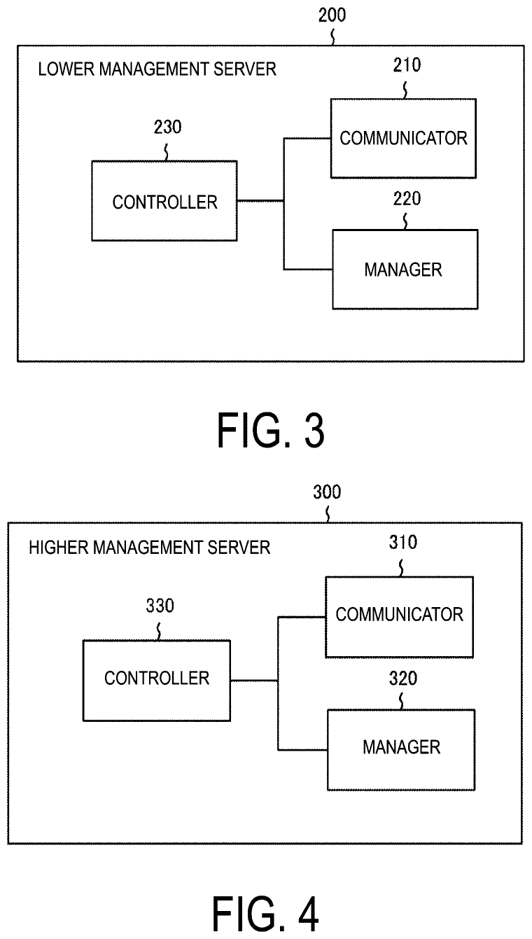

A case in which the lower management server 200 is managed by the RA will be described as an example. The lower management server 200 may be also referred to as the RA, and the RA may be also referred to as the lower management server 200. The lower management server 200 will be described later in detail (see FIG. 3).

In the embodiment, the lower management server 200 may include a power management apparatus that manages one or more facilities 100 (hereinafter, also referred to as a facility group 100).

The higher management server 300 is managed by an operator that manages power related to the power system 12. The higher management server 300 may be managed by an operator that provides various types of services. The higher management server 300 may be also referred to as an area energy management system (AEMS). The operator may be an electricity retailer. Examples of the electricity retailer may include a local power provider (general electricity operator) that manages infrastructure such as the power system 12, and may include a new power provider other than the local power provider. The new power provider may be assumed to procure power from an electricity market and sell the power to a facility. The electricity market may include a wholesale electricity market for trading of power (procured power) supplied to the facility 100. The electricity market may include a power adjustment market for adjusting a gap between demand and supply of power after gate closure of the wholesale electricity market and may include a capacity market for trading of supply power (reverse power flow power). The electricity market may include a market for trading of power with other electricity retailers. The electricity market may include a market for trading of power with other power generation operators. That is, the electricity market is not limited to a form of one-to-one, one-to-other, or many-to-many, and it may be an exchange for trading power.

The service may include a service for suppressing, to a predetermined difference or less, a difference (imbalance) between a planned value for the forward power flow power (hereinafter, also referred to as “procured power”) of the facility group 100 and an actual value for the procured power of the facility group 100. The service may also include a service for suppressing, to a predetermined difference or less, a difference (imbalance) between a planned value for the reverse power flow power (hereinafter, also referred to as “generation power”) of the facility group 100 and an actual value for the generation power of the facility group 100.

A case in which the higher management server 300 is managed by a new power provider will be described as an example. The higher management server 300 is also referred to as the new power provider, and the new power provider is also referred to as the higher management server 300. The higher management server 300 will be described later in detail (see FIG. 4).

In the embodiment, the new power provider may be one example of the electricity retailer that sells power to each of the one or more facilities 100.

The third party server 400 is managed by an operator that manages a power supply-demand balance of the power system 12. The operator may manage the electricity market related to the power system 12. For example, the third party server 400 may have a function of checking an imbalance of the procured power. The third party server 400 may have a function of checking an imbalance of the generation power. For example, the third party server may perform the following operations.

First, the third party server 400 may check whether or not a difference (imbalance) between the planned value for the procured power and an actual value for the procured power exceeds a predetermined difference. The planned value and the actual value may be collected for a unit period (for example, every 30 minutes), and the imbalance may be checked for a unit period (for example, every 30 minutes). The third party server 400 may impose a penalty on an operator that manages the higher management server 300 (for example, the new power provider) when the imbalance exceeds the predetermined difference. The third party server 400 may provide an incentive to an operator that manages the higher management server 300 (for example, the new power provider) when the imbalance does not exceed the predetermined difference. The penalty and the incentive may be financially provided.

Second, the third party server 400 may check whether or not a difference (imbalance) between the planned value for the generation power and an actual value of the generation power exceeds a predetermined difference. The planned value and the actual value may be collected for a unit period (for example, every 30 minutes), and the imbalance may be checked for a unit period (for example, every 30 minutes). The third party server 400 may impose a penalty on an operator that manages the higher management server 300 (for example, the new power provider) when the imbalance exceeds the predetermined difference. The third party server 400 may provide an incentive to an operator that manages the higher management server 300 (for example, the new power provider) when the imbalance does not exceed the predetermined difference. The penalty and the incentive may be financially provided.

Here, the period during which the imbalance is checked for the generation power and the procured power may be defined as a subject period (for example, one day). In such a case, the planned value for the procured power may include a plan formulated at a time prior to the subject period (for example, 12:00 on the previous day of the subject period). The planned value for the generation power may include a planned value formulated at a time prior to the subject period (for example, 12:00 on the previous day of the subject period). The planned value for the procured power may include a planned value formulated at a time prior to the unit period included in the subject period (for example, one hour prior to the unit period). The planned value for the generation power may include a planned value formulated at a time prior to the unit period included in the subject period (for example, one hour prior to the unit period).

Although no particular limitation is intended, the planned value for the procured power and the actual value for the procured power may be reported from the lower management server 200 or the higher management server 300. The planned value for the generation power and the actual value for the generation power may be reported from the lower management server 200 or the higher management server 300.

### Facility

The facility according to the embodiment will be described below. As illustrated in FIG. 2, the facility 100 includes a solar cell apparatus 110, a power storage apparatus 120, a fuel cell apparatus 130, a load unit 140, and an energy management system (EMS) 160. The facility 100 may include a measurement apparatus 190.

The solar cell apparatus 110 is a distributed power supply that generates power in response to sunlight or other light. For example, the solar cell apparatus 110 includes a power conditioning system (PCS) and a solar panel. In this case, being installed may mean that the solar cell apparatus 110 and the power system 12 are connected to each other.

The power storage apparatus 120 is a distributed power supply that charges and discharges power. For example, the power storage apparatus 120 includes a PCS and a power storage cell. In this case, being installed may mean that the power storage apparatus 120 and the power system 12 are connected to each other.

The fuel cell apparatus 130 is a distributed power supply that generates power using a fuel. For example, the fuel cell apparatus 130 includes a PCS and a fuel cell. In this case, being installed may mean that the fuel cell apparatus 130 and the power system 12 are connected to each other.

For example, the fuel cell apparatus 130 may be a solid oxide fuel cell (SOFC), a polymer electrolyte fuel cell (PEFC), a phosphoric acid fuel cell (PAFC), and a molten carbonate fuel cell (MCFC).

The load unit 140 consumes power. For example, the load unit 140 may include an air conditioning apparatus, a heat-pump hot-water supplying unit, and a lighting device.

The EMS 160 manages the power related to the facility 100. The EMS 160 may control the solar cell apparatus 110, the power storage apparatus 120, the fuel cell apparatus 130, and the load unit 140. In the embodiment, the EMS 160 is given as an example of an apparatus that receives a control command from the lower management server 200. Such a device may be referred to as Gateway or may be simply referred to as a controlling unit.

In order to make distinction from the lower management server 200, the EMS 160 may be referred to as a local EMS (LEMS), or may be referred to as a home EMS (HEMS), or may be referred to as a virtual power plant (VPP) controller.

The measurement apparatus 190 measures the forward power flow power (hereinafter, also referred to as demand power) from the power system 12 to the facility 100. The measurement apparatus 190 may measure the reverse power flow power from the facility 100 to the power system 12. For example, the measurement apparatus 190 may be a Smart Meter that belongs to a power company. The measurement apparatus 190 may transmit an information element indicating a measurement result (an integrated value of the forward power flow power or the reverse power flow power) at a first interval (for example, 30 minutes) to the EMS 160 for each first interval. The measurement apparatus 190 may transmit an information element indicating a measurement result at a second interval (e.g., one minute) shorter than the first interval to the EMS 160.

### Lower Management Server

The lower management server according to the embodiment will be described below. As illustrated in FIG. 3, the lower management server 200 includes a communicator 210, a manager 220, and a controller 230.

The communicator 210 includes a communication module. The communication module may be a wireless communication module compliant with standards such as IEEE 802.11a/b/g/n/ac/ax, ZigBee, Wi-SUN, LTE, 5G, and 6G, or may be a wired communication module compliant with standards such as IEEE 802.3.

The communicator 210 may receive facility information on the facility 100. The facility information may include information indicating the configuration of a distributed power supply that the facility 100 includes, and also may include information indicating specifications of the distributed power supply that the facility 100 includes. The facility information may include information (reverse-power-flow availability information) indicating whether or not the facility 100 indicates the reverse power flow. The reverse-power-flow availability information may be information indicating whether or not the facility 100 includes a distributed power supply in which the reverse power flow is permitted. The reverse-power-flow availability information may be referred to as a reverse-power-flow availability flag.

Note that the communicator 210 may receive a planned value for the generation power of each of the facilities 100. The communicator 210 may receive a planned value for the demand power of each of the facilities 100.

The communicator 210 may transmit a control command for controlling an apparatus installed at each of the facilities 100. The apparatus installed at each of the facilities 100 may include a distributed power supply such as the solar cell apparatus 110, the power storage apparatus 120, and the fuel cell apparatus 130. The apparatus installed at each of the facilities 100 may also include the load unit 140.

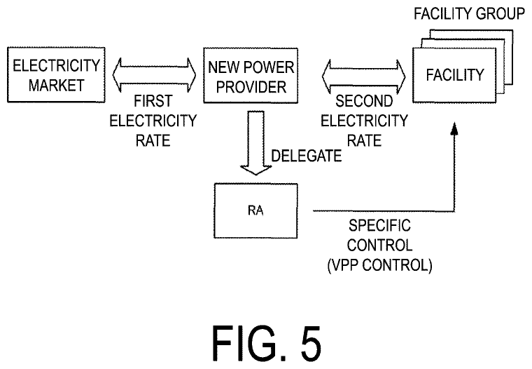

In the embodiment, the communicator 210 may include a receiving unit that receives first rate-related information on a first electricity rate determined between the electricity retailer and the electricity market. The communicator 210 may receive second rate-related information on a second electricity rate determined between the electricity retailer and each of the one or more facilities 100. The first electricity rate, the first rate-related information, the second electricity rate, and the second rate-related information will be described later in detail (see FIG. 5).

In the embodiment, the communicator 210 may include a notifying unit that notifies the electricity retailer (higher management server 300) of a result of specific control that will be described later. The result of the specific control may include an actual value for the generation power of each of the facilities 100, and may include an actual value for demand power of each of the facilities 100. The result of the specific control may include a result of collecting actual values for the generation power of each of the facilities 100, and may include a result of collecting actual values for the demand power of each of the facilities 100.

The manager 220 includes a storage medium such as a hard disk drive (HDD), a solid state drive (SSD), or a non-volatile memory.

In the embodiment, the manager 220 may include a manager that manages one or more facilities 100 connected to the power system 12. The manager 220 may manage information on the facilities 100. For example, the information related to the facilities 100 includes a type of the distributed power supply (the solar cell apparatus 110, the power storage apparatus 120, or the fuel cell apparatus 130) provided at the facility 100, specifications of the distributed power supply (the solar cell apparatus 110, the power storage apparatus 120, or the fuel cell apparatus 130) provided at the facility 100. The specifications may include a rated generated power of the solar cell apparatus 110, a rated charge power of the power storage apparatus 120, a rated discharge power of the power storage apparatus 120, and a rated output power of the fuel cell apparatus 130. The specifications may include a rated capacity and a maximum charge-discharge power of the power storage apparatus 120.

The controller 230 may include at least one processor. The at least one processor may be constituted by a single integrated circuit (IC) or by a plurality of circuits (such as integrated circuits and/or discrete circuits) connected communicably with each other.

In the embodiment, the controller 230 may include a controller that performs specific control to control a distributed power supply installed at each of the one or more facilities 100. The controller 230 performs the specific control based on the first rate-related information. The controller 230 may perform the specific control based on the second rate-related information in addition to the first rate-related information. Details of the specific control will be described later (see FIG. 5).

### Higher Management Server

The higher management server according to the embodiment will be described below. As illustrated in FIG. 4, the higher management server 300 includes a communicator 310, a manager 320, and a controller 330.

The communicator 310 includes a communication module. The communication module may be a wireless communication module compliant with standards such as IEEE 802.11a/b/g/n/ac/ax, ZigBee, Wi-SUN, LTE, 5G, and 6G, or may be a wired communication module compliant with standards such as IEEE 802.3.

For example, when a supply-demand balance of the power system 12 needs to be adjusted, the communicator 310 may transmit, to the lower management server 200, an adjustable-power request to inquire about the amount of power that can be adjusted by the facility group 100. As a response to the adjustable-power request, the communicator 310 may receive, from the lower management server 200, an adjustable-power response including the amount of power that can be adjusted by the facility group 100 (hereinafter, referred to as an adjustable amount).

For example, when a supply-demand balance of the power system 12 needs to be adjusted, the communicator 310 may transmit, to the lower management server 200, an adjustment instruction to give an instruction to adjust at least any one of the procured power or the adjusted power. As a response to the adjustment instruction, the communicator 310 may receive, from the lower management server 200, an adjustment result of at least any one of the procured power or the adjusted power.

In the embodiment, the communicator 310 may transmit, to the lower management server 200, the first rate-related information on the first electricity rate determined between the electricity retailer and the electricity market. The communicator 310 may transmit, to the lower management server 200, the second rate-related information on the second electricity rate determined between the electricity retailer and each of the one or more facilities.

The manager 320 includes a storage medium such as a hard disk drive (HDD), a solid state drive (SSD), or a non-volatile memory.

For example, the manager 320 may manage the amount of power that can be adjusted by the facility group 100.

The controller 330 may include at least one processor. The at least one processor may be constituted by a single integrated circuit (IC) or by a plurality of circuits (such as integrated circuits and/or discrete circuits) connected communicably with each other.

For example, the controller 330 may instruct the communicator 310 to transmit the adjustment instruction described above, based on the amount of power that can be adjusted by the facility group 100. The adjustment power amount instructed by the adjustment instruction may be the adjustable amount itself, or may be the amount of power allocated up to the adjustable amount.

### Electricity Rate and Specific Control

The electricity rate and the specific control according to the embodiment will be described below.

First, the electricity rate will be described with reference to FIG. 5. As illustrated in FIG. 5, the new power provider procures power from the electricity market, and sells the power to each of the facilities 100. The new power provider may own a distributed power supply in addition to the electricity market. Examples of the distributed power supply may include a solar cell apparatus, a power storage apparatus, and a fuel cell apparatus. An example of the distributed power supply that the new power provider owns may include a distributed power supply installed at the facility 100. Such a model may be referred to as a third-party owned model.

Under such a background, the first electricity rate is an electricity rate determined between the new power provider and the electricity market. The first electricity rate may include a rate for power that the new power provider procures (or purchases) from the electricity market. The first electricity rate may include a rate for power that the new power provider supplies (or sells) to the electricity market. The first electricity rate may include a fee for a penalty or incentive related to adjustment of the imbalance described above. The first electricity rate may include a transmission charge paid to an electricity transmission and distribution utility that supplies power to the facility 100.

Here, the first electricity rate is an electricity rate that changes more dynamically than the second electricity rate that will be described later. For example, the first electricity rate may include a rate for power traded in the electricity market in real time. The first electricity rate may be referred to as dynamic pricing.

For example, the first rate-related information may include information indicating the first electricity rate that changes from moment to moment. The first rate-related information may include information indicating the first electricity rate for every certain period of time (for example, 30 minutes, one hour, six hours, or the like). The first electricity rate for each certain period of time may be assumed based on the forecast of a power supply-demand balance in the electricity market. In such a case, the first rate-related information may be transmitted from the new power provider to the RA at a time when the first electricity rate is changed, or may be periodically transmitted.

On the other hand, the second electricity rate is an electricity rate determined between the new power provider and each of the one or more facilities 100. The second electricity rate may include a rate for forward power flow power (demand power) of the facility 100. The second electricity rate may include a rate for reverse power flow power (generation power) of the facility 100. The second electricity rate may include a benefit provided to each of the facilities 100 from the new power provider through control (specific control) of a distributed power supply installed at each of the facilities 100. The benefit may be a monetary or other benefit (for example, green power certificate, environmental added value, or the like). Note that the other benefit may be convertible to money based on a predetermined rule.

Here, the second electricity rate may be set in a static manner or substantially static manner based on a contract or the like between the new power provider and the facility 100.

For example, the second rate-related information may include information indicating a rate for demand power for each time period (for example, a time period during daytime, a time period during night time, or the like), information indicating a rate for generation power for each time period, and information indicating a rate for the benefit provided from the new power provider to the facility 100 by the specific control. When the second electricity rate is set in a static manner or a quasi-static manner, the second rate-related information may be considered to be information indicating a rate system for the second electricity rate. In such a case, the second rate-related information may be transmitted from the new power provider to the RA at timing at which the second electricity rate is changed, or may be transmitted one-time before the specific control.

The second electricity rate may vary for each facility 100, although not particularly limited. For example, the second electricity rate may vary depending on the magnitude of the demand power expected at the facility 100, the magnitude of the generation power expected at the facility 100, whether or not the facility 100 includes a distributed power supply of the third-party owned model, whether or not the facility 100 includes a distributed power supply that can be controlled by the RA, or the like.

Secondly, the specific control will be described with reference to FIG. 5. As illustrated in FIG. 5, the RA performs the specific control to control a distributed power supply installed at each of the facilities 100. The specific control may be referred to as VPP control. The specific control may be considered to be control to adjust the power supply-demand balance of the power system 12, or may be considered to be control to adjust an imbalance of the procured power or the generation power. The RA may be considered to be delegated by the new power provider. The RA may be considered to be delegated by the new power provider so as to adjust the imbalance of the procured power or the generation power.

Here, the RA (the controller 230 in the embodiment) performs the specific control based on the first rate-related information. Specifically, the RA may perform the specific control based on the first rate-related information so as to maximize the profit of the new power provider.

For example, in a predetermined period of time (for example, one day), the RA may perform the specific control to minimize a rate for power (hereinafter, referred to as a procurement electricity rate) procured from the electricity market. In a predetermined period of time (for example, one day), the RA may perform the specific control to maximize a rate for power (hereinafter, referred to as a supplied electricity rate) to be supplied to the electricity market. In a predetermined period of time (for example, one day), the RA may perform the specific control to maximize the incentive. In a predetermined period of time (for example, one day), the RA may perform the specific control to minimize the penalty. The RA may perform the specific control to maximize the profit of the new power provider based on two or more parameters selected from among the procurement electricity rate, the supplied electricity rate, the incentive, and the penalty. In such a case, as the procurement electricity rate and the supplied electricity rate, a rate assumed based on the forecast of the power supply-demand balance in the electricity market may be used.

The RA (the controller 230 in the embodiment) performs the specific control based on the second rate-related information in addition to the first rate-related information. In such a case, the RA may perform the specific control based on the first rate-related information under a constraint that prioritizes the profit of each of the one or more facilities 100 based on the second rate-related information. Here, the constraint that prioritizes the profit of the facility 100 may be considered to be a constraint that the facility 100 is not disadvantaged by the specific control.

For example, the constraint that prioritizes the profit of the facility 100 may be a constraint that minimizes the demand power of the facility 100, or may be a constraint that does not increase the demand power of the facility 100 above the planned value, in a predetermined period of time (for example, one day). The constraint that prioritizes the profit of the facility 100 may be a constraint that maximizes the generation power of the facility 100, or may be a constraint that does not reduce the generation power of the facility 100 below the planned value, in a predetermined period of time (for example, one day).

Note that the constraint that prioritizes the profit of the facility 100 may be a constraint that the demand power of the facility 100 is within an allowable range. For example, the allowable range may be a range between the power that is a minimized demand power of the facility 100 (hereinafter, referred to as minimized power) and the power that is larger than the minimized power by a predetermined power. The predetermined power may be determined in advance between the facility 100 and the power retailer. Note that, even in such a case, the profit of the facility 100 is prioritized to some extent.

When, in a predetermined period of time (for example, one day), the rate for the demand power is expected to increase by the specific control, the constraint that prioritizes the profit of the facility 100 may be a constraint that the benefit provided to the facility 100 by the specific control is equal to or more than the increase in the rate for the demand power. For example, the case where the rate for the demand power increases by the specific control may include a case where at least part of the generation power from the solar cell apparatus 110 is provided as the reverse power flow power without consuming the generation power from the solar cell apparatus within the facility 100. The case where the rate for the demand power increases by the specific control may include a case where charging control to compensate for discharged power of the power storage apparatus 120 is performed when the discharging control of the power storage apparatus 120 is performed as the specific control.

The constraint that prioritizes the profit of the facility 100 may be a constraint that the benefit provided to the facility 100 by the specific control is within an allowable range. For example, the allowable range may be a range between an increased rate for the demand power (hereinafter, referred to as an increased rate) and a rate that is larger than the increased rate by a predetermined rate. The predetermined rate may be determined between the facility 100 and the power retailer. Note that, even in such a case, the profit of the facility 100 is prioritized to some extent.

As described above, the constraint that prioritizes the profit of the facility 100 may be a constraint that prioritize the profit of the facility 100 to the greatest extent possible, or may be a constraint that prioritizes the profit of the facility 100 to some extent.

### Power Management Method

A power management method according to the embodiment will be described below.

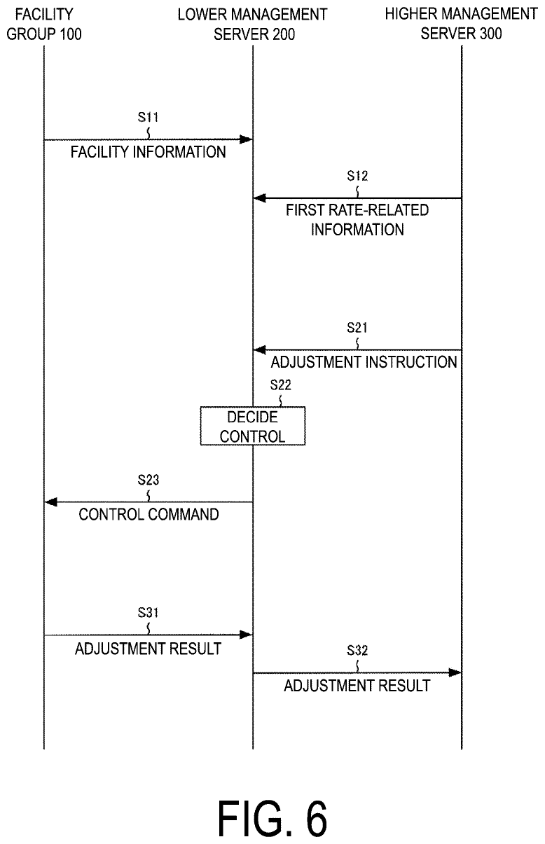

First, with reference to FIG. 6, description will be made of a case where the first rate-related information is used without using the second rate-related information.

As illustrated in FIG. 6, in step S11, the lower management server 200 receives facility information from the facility 100. The facility information may include information indicating the configuration of a distributed power supply that the facility 100 includes, and also may include information indicating specifications of the distributed power supply that the facility 100 includes. The facility information may include information (reverse-power-flow availability information) indicating whether or not the facility 100 indicates the reverse power flow.

In step S12, the lower management server 200 receives the first rate-related information from the higher management server 300. The lower management server 200 may receive the first rate-related information at timing when the first electricity rate is changed, or may periodically receive the first rate-related information.

In step S21, when the supply-demand balance of the power system 12 needs to be adjusted, the higher management server 300 transmits, to the lower management server 200, an adjustment instruction used to give an instruction to adjust one of the generation power and the procured power.

In step S22, the lower management server 200 determines details of the specific control to be applied to the distributed power supply installed at the facility 100, based on the first rate-related information. Specifically, the lower management server 200 may determine details of the specific control such that the profit of the new power provider is maximized, based on the first rate-related information.

In step 23, the lower management server 200 transmits, to the facility 100, a control command that gives an instruction of the specific control determined in step S22.

In step S31, the facility group 100 transmits a post-performance actual value to the lower management server 200. The post-performance actual value may include an actual value for the generation power of each of the facilities 100, and may include an actual value for the demand power of each of the facilities 100.

In step S32, the lower management server 200 may collect the post-performance actual value of each of the facilities 100 and transmit the post-performance actual value of the facility group 100 to the higher management server 300. The lower management server 200 or the higher management server 300 may transmit the post-performance actual value of the facility group 100 to the third party server 400. The post-performance actual value may include an actual value for the generation power of the facility group 100, and may include an actual value for the procured power of the facility group 100.

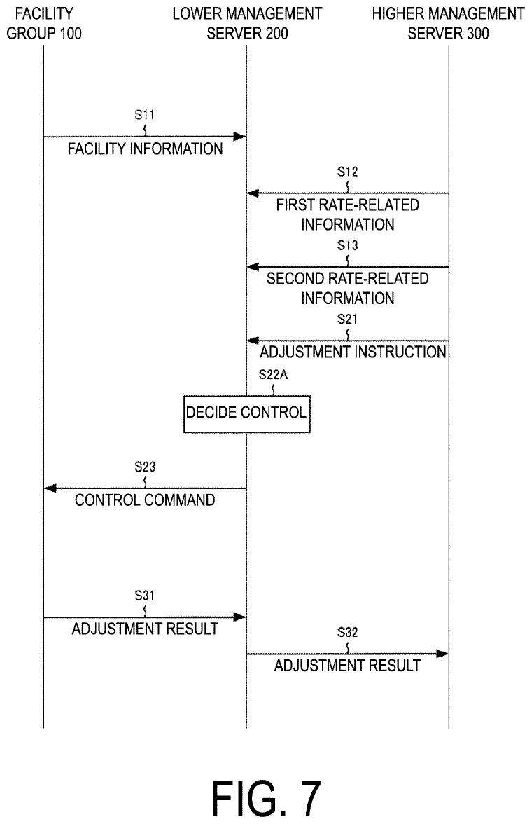

Second, with reference to FIG. 7, description will be made of a case where the second rate-related information is used in addition to the first rate-related information. The sequence illustrated in FIG. 7 is same as and/or similar to the sequence illustrated in FIG. 6 except that step S13 is added, and step S22A is performed instead of step S22. Thus, explanation of steps same as and/or similar to those in FIG. 6 will not be repeated.

In step S13, the lower management server 200 receives the second rate-related information from the higher management server 300. The lower management server 200 may receive the second rate-related information at timing when the second electricity rate is changed, or may periodically receive the second rate-related information one-time before the specific control.

In step S22A, the lower management server 200 determines details of the specific control to be applied to the distributed power supply installed at the facility 100, based on the second rate-related information in addition to the first rate-related information. Specifically, the lower management server 200 may determine details of the specific control based on the first rate-related information under a constraint that prioritizes the profit of each of the one or more facilities 100 based on the second rate-related information.

### Actions and Effects

In the embodiment, the lower management server 200 performs the specific control to control the distributed power supply installed at each of the one or more facilities 100, based on the first rate-related information received from the higher management server 300. Such a configuration makes it possible to suppress a reduction in the profit of the electricity retailer (higher management server 300) that sells the power to the facility 100, under a situation in which the first electricity rate changes from moment to moment.

In the embodiment, the lower management server 200 may perform the specific control to control the distributed power supply installed at each of the one or more facilities 100 based on the second rate-related information in addition to the first rate-related information. Such a configuration makes it possible to suppress a reduction in the profit of the electricity retailer while still taking into account the profit of the facility 100.

### Other Embodiments

Although the present disclosure is described by the above-described embodiment, it should not be understood that the description and the drawings, which form a part of this disclosure, limit this invention. Various alternative embodiments, examples, and operational techniques will be apparent from this disclosure to those skilled in the art.

Although not specifically mentioned in the disclosure above, the lower management server 200 (RA) may determine whether or not to perform the specific control, based on the second rate-related information (the benefit provided to the facility 100 from the power retailer by the specific control). For example, the lower management server 200 (RA) may determine whether or not the profit of the electricity retailer reduces by the specific control, based on the second rate-related information. The lower management server 200 (RA) may perform the specific control when the profit of the electricity retailer does not reduce, without performing the specific control when the profit of the electricity retailer reduces. The lower management server 200 (RA) may determine whether or not the profit of the facility 100 increases by the specific control, based on the second rate-related information. The lower management server 200 (RA) may perform the specific control when the profit of the facility 100 increases, without performing the specific control when the profit of the facility 100 does not increase.

Although not specifically mentioned in the disclosure above, the facility 100 may transmit, to the lower management server 200 (RA), information regarding participation in the specific control. For example, the facility 100 may transmit, to the lower management server 200 (RA), information indicating whether or not to participate in the specific control, or may transmit, to the lower management server 200 (RA), information indicating a condition for participation in the specific control (for example, a condition regarding the profit obtained by the facility 100).

Although not specifically mentioned in the disclosure above, the first rate-related information may be considered to be information referred to in order to suppress a reduction in the profit of the electricity retailer that sells power to the facility 100. The first rate-related information may be considered to be information that the lower management server 200 (RA) does not need to obtain, assuming only the perspective of maximizing the profit of the facility 100. The first rate-related information may be considered to be information that the lower management server 200 (RA) cannot directly know. The lower management server 200 (RA) may receive the first rate-related information from the higher management server 300 (electricity retailer) that has a trading relationship with the electricity market, or may receive the first rate-related information from an operator (an operator or the like that manages the power supply-demand balance of the power system 12) that manages the electricity market.

Although not specifically mentioned in the disclosure above, the second rate-related information may be considered to be information referred to in order to prioritize the profit of the facility 100. The second rate-related information may be considered to be information that the lower management server 200 (RA) cannot directly know. The lower management server 200 (RA) may receive the second rate-related information from the higher management server (electricity retailer) that has a trading relationship with the electricity market, or may receive the second rate-related information from the facility 100.

Although not specifically mentioned in the disclosure above, the specific control may be considered to be control of the distributed power supply installed at the facility 100 for the electricity retailer that sells power to the facility 100, that is, in order to adjust the imbalance of the procured power or the generation power.

Although not specifically mentioned in the disclosure above, the distributed power supply that the lower management server 200 can control may include the power storage apparatus 120. Note that the distributed power supply that the lower management server 200 can control may include a distributed power supply that can control the output power as appropriate. For example, the distributed power supply that the lower management server 200 can control may include the fuel cell apparatus 130, and a power generation unit.

Although not specifically mentioned in the disclosure above, the lower management server 200 and the higher management server 300 may be realized by one server, and the lower management server 200 and the higher management server 300 may be managed by one operator.

Although not specifically mentioned in the disclosure above, the adjustment instruction may include the adjustment power amount (for example, 100 kW) instructed to the lower management server 200. The adjustment instruction may include the time of day (for example, YYYYMMDDS) at which adjustment starts.

Although not specifically mentioned in the disclosure above, the adjustment result may be a message including any one adjustment result of the generation power and the procured power. When the generation power is adjusted, the adjustment result may include the adjustable power for the generation power (for example, 60 kW). When the procured power is adjusted, the adjustment result may include the adjustable power for the procured power (for example, 10 KW). The adjustment result may include the time of day (for example, YYYYMMDDS) at which the adjustment starts.

Although the term “generation power” is mainly used in the disclosure above, the “generation power” may also be read as “reverse power flow power”.

Although the term “procured power” is mainly used in the disclosure above, the “procured power” may also be read as “forward power flow power”. The procured power may be considered to be a term used for the forward power flow power of the facility group 100, and the demand power may be considered to be a term used for the forward power flow power of each of the facilities 100.

Although not specifically mentioned in the disclosure above, the power may be expressed as an instantaneous value (W/KW) or may be expressed as an integrated value per unit time (Wh/kWh).

Although not specifically mentioned in the disclosure above, it may be possible to provide a program that causes a computer to perform each process that the EMS 160 and the lower management server 200 perform. The program may be recorded in a computer-readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

A chip may be provided that includes a memory that stores a program for executing each process that the EMS 160 and the lower management server 200 perform, and a processor that executes the program stored in the memory.

The above disclosure may have the following problems and effects.

In general, the power management apparatus performs control to maximize the profit of a facility based on the electricity rate (second electricity rate) defined in a contract between the electricity retailer and the facility. For example, the control of the power management apparatus may include control to maximize the incentive provided from the electricity retailer by adjusting the imbalance, and control to minimize the rate for power purchased from the electricity retailer.

As the electricity rate (first electricity rate) defined between the electricity market and the electricity retailer, an electricity rate that changes more dynamically than the electricity rate (second electricity rate) defined in the contract between the electricity retailer and the facility may be introduced.

In view of the circumstances described above, as a result of diligent study by the inventors of the present disclosure, they have newly known the possibility that the control based on the second electricity rate may reduce the profit of the electricity retailer, and found that the first electricity rate that changes more dynamically than the second electricity rate needs to be taken into account.

According to the disclosure described above, the power management apparatus, the power management method, and the program that make it possible to suppress a reduction in the profit of the electricity retailer can be provided.

### Supplementary Note

The disclosure above may be expressed as follows.

A first feature provides a power management apparatus including: a manager configured to manage one or more facilities connected to a power system; a controller configured to perform specific control to control a distributed power supply installed at each of the one or more facilities; and a receiving unit configured to receive first rate-related information regarding a first electricity rate determined between an electricity market and an electricity retailer that sells power to each of the one or more facilities, in which the controller performs the specific control based on the first rate-related information.

In the first feature, a second feature provides a power management apparatus, in which the receiving unit receives second rate-related information regarding a second electricity rate determined between each of the one or more facilities and the electricity retailer, and the controller performs the specific control based on the second rate-related information in addition to the first rate-related information.

In the second feature, a third feature provides a power management apparatus, in which the controller performs the specific control based on the first rate-related information under a constraint that prioritizes a profit of each of the one or more facilities based on the second rate-related information.

In the second or third feature, a fourth feature provides a power management apparatus, in which the first electricity rate is an electricity rate that changes more dynamically than the second electricity rate.

In any one of the second to fourth features, a fifth feature provides a power management apparatus, in which the second rate-related information includes information regarding a benefit provided from the electricity retailer to each of the one or more facilities by the specific control.

In the fifth feature, a sixth feature provides a power management apparatus, in which the controller determines, based on the second rate-related information, whether or not to perform the specific control.

In any one of the first to sixth features, a seventh feature provides a power management apparatus including a notifying unit configured to notify the electricity retailer of a result of the specific control.

An eighth feature provides a power management method including: managing one or more facilities connected to a power system; performing specific control to control a distributed power supply installed at each of the one or more facilities; and receiving first rate-related information regarding a first electricity rate determined between an electricity market and an electricity retailer that sells power to each of the one or more facilities, in which the performing of the specific control includes performing the specific control based on the first rate-related information.

A ninth feature provides a program that causes a computer to perform: managing one or more facilities connected to a power system; performing specific control to control a distributed power supply installed at each of the one or more facilities; and receiving first rate-related information regarding a first electricity rate determined between an electricity market and an electricity retailer that sells power to each of the one or more facilities, in which the performing of the specific control includes performing the specific control based on the first rate-related information.

1. A power management apparatus comprising:
a manager configured to manage one or more facilities connected to a power system;
a controller configured to perform specific control to control a distributed power supply installed at each of the one or more facilities; and
a receiving unit configured to receive first rate-related information regarding a first electricity rate determined between an electricity market and an electricity retailer that sells power to each of the one or more facilities, wherein
the controller performs the specific control based on the first rate-related information.

2. The power management apparatus according to claim 1, wherein
the receiving unit receives second rate-related information regarding a second electricity rate determined between each of the one or more facilities and the electricity retailer, and
the controller performs the specific control based on the second rate-related information in addition to the first rate-related information.

3. The power management apparatus according to claim 2, wherein
the controller performs the specific control based on the first rate-related information under a constraint that prioritizes a profit of each of the one or more facilities based on the second rate-related information.

4. The power management apparatus according to claim 2, wherein
the first electricity rate is an electricity rate that changes more dynamically than the second electricity rate.

5. The power management apparatus according to claim 2, wherein
the second rate-related information comprises information regarding a benefit provided from the electricity retailer to each of the one or more facilities by the specific control.

6. The power management apparatus according to claim 5, wherein
the controller determines, based on the second rate-related information, whether or not to perform the specific control.

7. The power management apparatus according to claim 1, comprising:
a notifying unit configured to notify the electricity retailer of a result of the specific control.

8. A power management method, comprising:
managing one or more facilities connected to a power system;
performing specific control to control a distributed power supply installed at each of the one or more facilities; and
receiving first rate-related information regarding a first electricity rate determined between an electricity market and an electricity retailer that sells power to each of the one or more facilities, wherein
the performing of the specific control comprises performing the specific control based on the first rate-related information.

9. A program that causes a computer to perform:
managing one or more facilities connected to a power system;
performing specific control to control a distributed power supply installed at each of the one or more facilities; and
receiving first rate-related information regarding a first electricity rate determined between an electricity market and an electricity retailer that sells power to each of the one or more facilities, wherein
the performing of the specific control comprises performing the specific control based on the first rate-related information.
